(19) United States
(12) Patent Application Publication
(10) Pub. No.: US 2008/0024428 A1
(43) Pub. Date: Jan. 31, 2008

(54) Electrophoretic Display Panel

(75) Inventors: Murray Gillies, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,198

(22) PCT Filed: May 11, 2005
(86) PCT No.: PCT/IB05/51546

§ 371 Date: Nov. 16, 2006

(30) Foreign Application Priority Data
May 28, 2004 (EP) 04102384.7

(51) Int. Cl. G02F 1/167

(52) U.S. Cl. 345/107

(57) ABSTRACT

For the electrophoretic display panel (1) to be able to be addressed by passive matrix techniques and to be used in light transmissive mode, the electrophoretic display panel (1) has a magnet (120) for generating a magnetic field, and a pixel (2) having electrodes (10,15) for receiving potentials for generating an electric field, an electrophoretic medium (5) having charged particles (6), the particles (6) having a net magnetic moment and being able to be moved to their position for displaying the picture by a combination of the electric and the magnetic field, an entrance window (92), and an exit window (91) for exiting a portion of transmissable light out of the pixel (2). Furthermore, the transmissable light is capable of having a lightpath from entering the pixel (2) via the entrance window (92), passing through the pixel (2) and exiting out of the pixel (2) via the exit window (91), the portion depending on the position of the particles (6). Furthermore, the magnet (120) is arranged outside the lightpath of at least part of the transmissable light for providing the entrance window (92) to be at least partly distinct from the exit window (91).

The invention relates to an electrophoretic display panel for displaying a picture.

The invention also relates to a display device comprising such an electrophoretic display panel.

A display panel for displaying a picture is disclosed in EP0962808.

Electrophoretic display panels in general are based on the motion of charged, usually colored particles under the influence of an electric field between electrodes. With these display panels, dark or colored characters can be imaged on a light or colored background, and vice versa. Electrophoretic display panels are therefore notably used in display devices taking over the function of paper, referred to as “paper white” applications, e.g. electronic newspapers and electronic diaries.

The disclosed electrophoretic display panel comprises a first substrate and second substrate disposed opposite to each other with a gap therebetween, and a first electrode and a second electrode which are disposed at horizontally deviated positions on the first substrate so as to provide an electric field therebetween for controlling a spatial distribution in the pixel. A transparent insulating liquid fills the gap between the first and second substrate. Magnetic positively charged black-colored electrophoretic particles are carried within the liquid and may be moved along the electric field between the first and second electrodes, i.e., horizontally relative to the first substrate. The first and the second electrodes are colored white and black, respectively. The first substrate is made magnetic by incorporation therein a magnetic powder. As a result, the particles experience an attractive magnetic force towards the first substrate. The particles are moved within the transparent insulating liquid in parallel with or horizontally with respect to the first substrate between the first electrode and the second electrode by applying a voltage between the first electrode and the second electrode, thereby effecting a display. Further, at the time of no voltage application or application of a voltage below a threshold given by a magnetic constraint acting between the particles and the first substrate, the position of the particles is fixed by attraction to the first substrate.

In this state, if a relatively large voltage is applied, i.e. a voltage larger than the threshold value, between the second electrode as a positive electrode and the first electrode as a negative electrode so as to exert onto the particles an electrostatic force which is larger than the magnetic force acting between the particles and the first substrate, the particles are moved and attached to the negative first electrode, so as to mask the first electrode with the black particles. As a result, the optical state of the pixel is black, following from the black color of the magnetic particles on the first electrode and the black color of the second electrode as observed by a viewer at the side of the second substrate.
Now, if a reverse polarity of relatively large voltage is applied between the first electrode as a positive electrode and the second electrode as a negative electrode, the particles are moved and attached onto the negative second electrode, whereby the optical state of the pixel is intermediate between black and white, following from the black color of the particles on the second electrode and the white color of the first electrode.

Thus, the provision of the magnetic particles and the magnetic first substrate provides a switching threshold for the particles in the pixel; the particles do not switch when the voltage is below the threshold value. This switching threshold is essential for being able to address the display panel by passive matrix techniques.

The display panel is used in light reflective mode. However, as the magnetic first substrate is substantially non-light transmissive, the display panel can not be used in light transmissive mode.

It is an object of the invention to provide an electrophoretic display panel which is able to be addressed by passive matrix techniques and which is able to be used in light transmissive mode.

To achieve this object, the invention provides an electrophoretic display panel for displaying a picture comprising
a magnet for generating a magnetic field,
a pixel comprising

electrodes for receiving potentials for generating an electric field,

an electrophoretic medium comprising charged particles, the particles having a net magnetic moment and being able to be moved to their position for displaying the picture by a combination of the electric and the magnetic field,

an entrance window, and

an exit window for exiting a portion of transmissable light out of the pixel, the transmissable light being capable of having a lightpath from entering the pixel via the entrance window, passing through the pixel and exiting out of the pixel via the exit window, the portion depending on the position of the particles,

the magnet being arranged outside the lightpath of at least part of the transmissable light for providing the entrance window to be at least partly distinct from the exit window.
As a result of the particles having a net magnetic moment and being able to be moved to their position for displaying the picture by a combination of the electric and the magnetic field, the display panel is able to be addressed by passive matrix techniques. Furthermore, the inventors have realized that by arranging the magnet outside the lightpath of at least part of the transmissable light for providing the entrance window to be at least partly distinct from the exit window, the display panel can be used in light transmissive mode. This is in contrast to the display panel disclosed in EP0962808, where the entrance window equals the exit window and the display panel can not be used in light transmissive mode.

In an embodiment the entrance window is distinct from the exit window. Then the transmissable light enters and exits the pixel at separated windows. If, furthermore, the entrance window is substantially parallel and opposite to the exit window, the display panel can be relatively simply manufactured as the transmissable light can enter the pixel at the backside of the panel and exit out of the pixel at the front, being the viewing, side. The display panel can relatively simply be operated if the entrance window is substantially axially aligned with the exit window.

In an embodiment the magnet is arranged to enable the particles to experience in the magnetic field an attracting magnetic force towards a member of the electrodes in a position adjacent to the member. If, furthermore, the magnet is adjacent to or part of the member, the amount of magnetic material used can be relatively small. If, furthermore, the member has a substantially flat surface facing the particles, the surface being substantially perpendicular to the entrance window, the magnet may obstruct only a relatively small portion of the light entering the pixel via the entrance window. The member may have a rough surface facing the particles, the surface being substantially perpendicular to the entrance window. Then the member is able to collect more particles. If, furthermore, the magnet is arranged to be substantially non-obstructive to the transmissable light, the power consumption is relatively low for a predetermined brightness level of the pixel.

In an embodiment the magnet is part of the member, the member is structured and has a surface being substantially parallel to the entrance window. Then the geometry of the electrodes and surfaces of the electrodes can be relatively simply manufactured. If, furthermore, the member is structured in a mesh form, the member can even more simply be manufactured. If, furthermore, the magnet is arranged to be substantially non-obstructive to the transmissable light, the power consumption is relatively low for a predetermined brightness level of the pixel.

In another embodiment the magnetic particles have a soft magnetic component. Then unnecessary clustering in the absence of a magnetic field is avoided.

In another embodiment, the display panel is an active matrix display panel.

Another aspect of the invention provides a display device comprising an electrophoretic display panel as claimed in claim 13.

These and other aspects of the display panel of the invention will be further elucidated and described with reference to the drawings, in which:

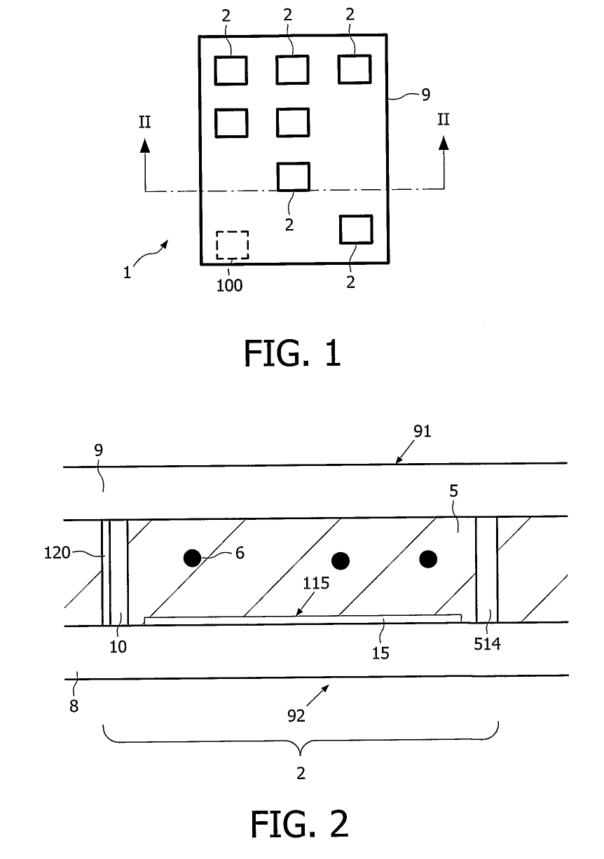

FIG. 1 shows diagrammatically a front view of an embodiment of the display panel;

FIG. 2 shows diagrammatically a cross-sectional view along II-II in FIG. 1;

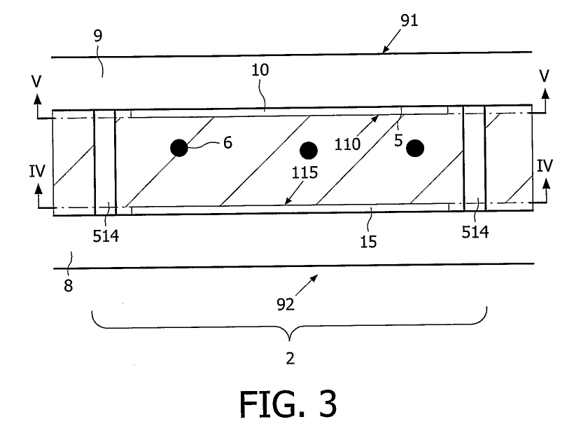

FIG. 3 shows diagrammatically a cross-sectional view along II-II in FIG. 1 of another embodiment of the display panel;

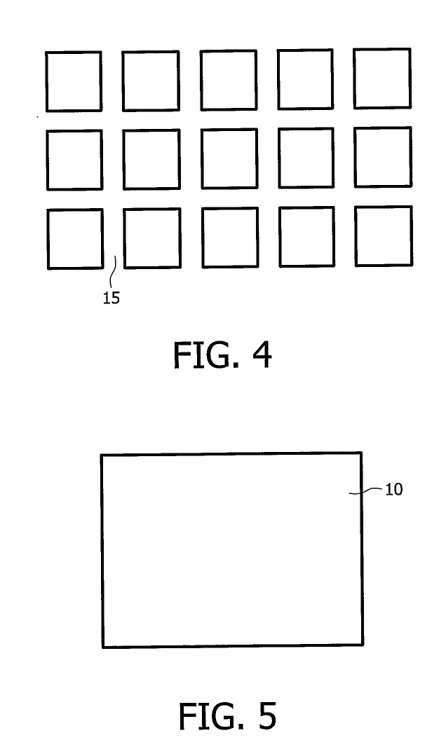

FIG. 4 shows diagrammatically a cross-sectional view along IV-IV in FIG. 3; and

FIG. 5 shows diagrammatically a cross-sectional view along V-V in FIG. 3.

In all the Figures corresponding parts are referenced to by the same reference numerals.

FIGS. 1 and 2 show an example of the display panel 1 having a first transparent substrate 8, a second transparent opposed substrate 9 and a plurality of pixels 2. Preferably, the pixels 2 are arranged along substantially straight lines in a two-dimensional structure. Other arrangements of the pixels 2 are alternatively possible, e.g. a honeycomb arrangement. In an active matrix embodiment, the pixels 2 may further comprise switching electronics, for example, thin film transistors (TFTs), diodes, MIM devices or the like.

An electrophoretic medium 5, having charged particles 6 in a transparant fluid, is present between the substrates 8,9. The particles 6 have a net magnetic moment, e.g. are ferromagnetic or ferrimagnetic. Electrophoretic media 5 having charged particles having a net magnetic moment are known per se from e.g. WO02/093245 and EP0962808, these documents being incorporated by reference herein. The particles are e.g. formed of iron tetroxide (Fe3O4), usually known as “magnetite” or “lodestone”, the most common mineral forms of this material. This material is inexpensive and can readily be reduced to the particle size range (about 0.25 to 5 micron) normally used in electrophoretic displays. Magnetite itself is of course black in color. In general, the magnetic particles used in the present invention may comprise a core of magnetic material and a shell of non-magnetic material substantially completely surrounding the core; the shell may itself bear a polymer coating or other surface treatment or may have any color.

The pixel 2 has an entrance window 92 for entering light into the pixel 2, e.g. from a (not drawn) backlight source, and an exit window 91 for exiting a portion of transmissable light out of the pixel 2. The transmissable light is capable of having a lightpath from entering the pixel 2 via the entrance window 92, passing through the pixel 2 and exiting out of the pixel 2 via the exit window 91. Furthermore, the optical state of the pixel 2 depends on the position of the particles 6 as the portion depends on the position of the particles 6. The light exiting out of the pixel 2 through the exit window 91 can be viewed by a viewer. The optical state of the pixel 2 is determined by the portion of the visible spectrum incident on the pixel 2 at the entrance window 92 that survives the cumulative effect of traversing through the pixel 2 and exits through exit window 91. Furthermore, the amount of the light transmitted through the pixel 2 is controlled by the position of the particles 6. When the particles 6 are positioned in the path of the light that enters the pixel 2, the particles 6 absorb a selected portion of the light and the remaining light is transmitted through the pixel 2. When the particles 6 are substantially removed from the path of the light entering the pixel 2, the light can pass through the pixel 2 and emerge without significant visible change. The light seen by the viewer, therefore, depends on the distribution of particles 6 in the pixel 2.

The pixel 2 has electrodes 10,15 which receive potentials from the drive means 100. Each one of the electrodes 10,15 may have a substantially flat surface facing the particles 6. The drive means 100 are arranged for controlling the potentials to enable a movement of the particles 6 to their position for displaying the picture.

The display panel 1 has a magnetic sheet 120, which may be formed from any convenient magnetic material, for example bonded ferrite, ceramic hard ferrite, aluminum-nickel-cobalt alloys (Alnico), or a rare earth magnetic material, such as samarium cobalt or neodymium iron boron, or a magnetic composite or a magnetic paste. The magnetic material should have north and south poles such that the particles 6 experience in a position adjacent to a member of the electrodes 10,15 an attracting magnetic force towards the member 10,15. For example, the magnetic material has north and south poles alternating transversely across the width of the magnetic sheet 120, with poling widths less than about 500 micron. Such magnets may be purchased from Group Arnold (300 N. West St., Marengo, Ill., 60152—Group Arnold is a Registered Trademark). The magnet is arranged outside the lightpath of at least part of the transmissable light for providing the entrance window 92 to be at least partly distinct from the exit window 91. In FIG. 2, the magnetic sheet 120 lies adjacent electrode 10. This is an example of the entrance window 92 being distinct from the exit window 91, being substantially parallel and opposite to the exit window 91, and being substantially axially aligned with the exit window 91. Furthermore, the magnet 120 is substantially non-obstructive to the transmissable light. Alternatively, the magnetic sheet 120 may be part of or incorporated in electrode 10. Furthermore, the barrier 514 forming a pixel wall may separate a pixel 2 from another pixel 2.

In an example, consider the particles 6 to be positively charged, magnetic and black. Furthermore, the fluid is transparent and electrode 15 is transparant. Consider the pixel layout of FIG. 2. The optical state of the pixel 2 is determined by the portion of the visible spectrum incident on the pixel 2 at the entrance window 92 that survives the cumulative effect of traversing through the first substrate 8, electrode 15, medium 5, the second substrate 9 and exits through exit window 91. Consider white light e.g. generated by a (back)light source (not drawn), incident on the entrance window 92.

To obtain an optical state being black the particles 6 are brought near the surface 115 of electrode 15 by appropriately changing the potentials received by the electrodes 10,15, e.g. the electrodes 10,15 receive 0 Volts and −10 Volts, respectively. The electric force on the particles 6 as a result of this potential difference is considered to be large enough to overcome the attracting magnetic force on the particles 6 towards electrode 10. As the white light from the light source incident on the pixel 2 is absorbed by the black particles 6, the optical state of the pixel 2 is black.
To obtain an optical state being white the particles 6 are brought in their collected state near the surface of electrode 10, by appropriately changing the potentials received by the electrodes 10,15, e.g. the electrodes 10,15 receive −10 Volts and 0 Volts, respectively. The movement of the particles 6 has a component in the plane parallel to the exit window 91 and the particles 6 are brought substantially outside the light path. Therefore, the white light from the light source is transmitted through the pixel 2 and the optical state of the pixel 2 is white. Intermediate optical states are also possible by appropriately changing the potentials received by the electrodes 10,15. In an example, only a small number of particles 6 are distributed in the pixel 2 thereby not fully absorbing the white light from the light source incident on the pixel 2, which results in an optical state being intermediate between black and white.

In another example, consider the pixel layout of FIGS. 3-5. Again, the particles 6 are positively charged, magnetic and black. Furthermore, the fluid is transparent and electrode 10 is transparant. Electrode 15 contains non-transparent magnetic material. Furthermore, electrode 15 is patterned into a mesh structure and is therefore not fully obstructive to light capable of entering through the entrance window 92 and exiting through the exit window 91. The optical state of the pixel 2 is determined by the portion of the visible spectrum incident on the pixel 2 at the entrance window 92 that survives the cumulative effect of traversing through the first substrate 8, the patterned electrode 15, medium 5, the electrode 10, the second substrate 9 and exits through exit window 91. Consider white light e.g. generated by a (back)light source (not drawn), incident on the entrance window 92.

To obtain an optical state being black the particles 6 are brought in their collected state near the surface 110 of electrode 10, by appropriately changing the potentials received by the electrodes 10,15, e.g. the electrodes 10,15 receive −10 Volts and 0 Volts, respectively. The electric force on the particles 6 as a result of this potential difference is considered to be large enough to overcome the attracting magnetic force on the particles 6 towards electrode 15. As the white light from the light source incident on the pixel 2 is absorbed by the black particles 6, the optical state of the pixel 2 is black.
To obtain an optical state being close to white the particles 6 are brought near the surface 115 of electrode 15 by appropriately changing the potentials received by the electrodes 10,15, e.g. the electrodes 10,15 receive 0 Volts and −10 Volts, respectively. As the particles 6 are near the surface of the patterned electrode 15, the particles 6 are brought substantially outside the light path. Therefore, a large portion of the white light from the light source is transmitted through the pixel 2 and the optical state of the pixel 2 is close to white.
Intermediate optical states are also possible by appropriately changing the potentials received by the electrodes 10,15. In an example, the particles 6 are distributed in the pixel 2 between the electrodes 10,15 thereby not fully absorbing the white light from the light source incident on the pixel 2, which results in an optical state being intermediate between black and close to white.

1. An electrophoretic display panel (1) for displaying a picture comprising
a magnet (120) for generating a magnetic field,
a pixel (2) comprising
electrodes (10,15) for receiving potentials for generating an electric field,
an electrophoretic medium (5) comprising charged particles (6), the particles (6) having a net magnetic moment and being able to be moved to their position for displaying the picture by a combination of the electric and the magnetic field,
an entrance window (92), and
an exit window (91) for exiting a portion of transmissable light out of the pixel (2), the transmissable light being capable of having a lightpath from entering the pixel (2) via the entrance window (92), passing though the pixel (2) and exiting out of the pixel (2) via the exit window (91), the portion depending on the position of the particles (6), the magnet (120) being arranged outside the lightpath of at least part of the transmissable light for providing the entrance window (92) to be at least partly distinct from the exit window (91).

2. A display panel (1) as claimed in claim 1 characterized in that the entrance window (92) is distinct from the exit window (91).

3. A display panel (1) as claimed in claim 2 characterized in that the entrance window (92) is substantially parallel and opposite to the exit window (91).

4. A display panel (1) as claimed in claim 3 characterized in that the entrance window (92) is substantially axially aligned with the exit window (91).

5. A display panel (1) as claimed in claim 1 characterized in that the magnet (120) is arranged to enable the particles (6) to experience in the magnetic field an attracting magnetic force towards a member of the electrodes in a position adjacent to the member.

6. A display panel (1) as claimed in claim 5 characterized in that the magnet (120) is adjacent to or part of the member.

7. A display panel (1) as claimed in claim 6 characterized in that the member has a substantially flat surface facing the particles (6), the surface being substantially perpendicular to the entrance window (92).

8. A display panel (1) as claimed in claim 7 characterized in that the magnet (120) is arranged to be substantially non-obstructive to the transmissable light.

9. A display panel (1) as claimed in claim 5 characterized in that the magnet (120) is part of the member, the member is structured and has a surface being substantially parallel to the entrance window (92).

10. A display panel (1) as claimed in claim 9 characterized in that the member is structured in a mesh form.

11. A display panel (1) as claimed in claim 10 characterized in that the magnet (120) is arranged to be substantially non-obstructive to the transmissable light.

12. A display panel (1) as claimed in claim 1 characterized in that the magnetic particles (6) have a soft magnetic component.

13. A display device comprising the display panel (1) as claimed in claim 1 and a circuitry to provide image information to the panel (1).
